(19) United States
(12) Patent Application Publication
(10) Pub. No.: US 2004/0253082 A1
(43) Pub. Date: Dec. 16, 2004

(54) Commissioning device

(76) Inventors: Andre Mathys, Ennetburgen (CH); Hans Koller, Horw (CH)

Correspondence Address: Browdy & Neimark, 624 Ninth Street NW, Washington, DC, 20001-5303, US

(21) Appl. No.: 10/490,100

(22) PCT Filed: Sep. 18, 2002
(86) PCT No.: PCT/CH02/00513

(30) Foreign Application Priority Data
Sep. 20, 2001 (CH) 1741/01

(51) Int. Cl. B65G 1/00

(52) U.S. Cl. 414/280

(57) ABSTRACT

The commissioning device comprises a transport device which conveys storage containers (1) from a warehouse (4) to a commissioning work station (3) (3) and returns them thereto (4). The storage containers to be commissioned (1) are presented on a displaceable table (9). The transport device comprises at least one vehicle (2) which transports the storage containers (1) from the warehouse (4) to the table (9) and which transports them back to the warehouse (4).

The invention relates to an order-picking apparatus with a transporting arrangement which transports storage containers from a store to a order-picking workstation and back again into the store.

The prior art has disclosed numerous order-picking apparatuses which have one or more order-picking workstations. The containers reach the order-picking workstation via an order-picking circuit. Once the storage containers have arrived at the order-picking workstation, then an order picker is given an indication as to the container compartment from which the articles are to be removed, the number of units which are to be picked and the destination. If the order picker has removed the corresponding articles from the storage container, then the latter is conveyed back into the store and, there, introduced into the corresponding compartment again.

EP 0 847 939 has disclosed an order-picking apparatus in which slow-moving and fast-moving containers are provided, these being fed to corresponding conveying channels which have endless conveying arrangements.

Order-picking apparatuses are intended to operate in a time-saving and functionally reliable manner. In addition, the order-picking workstation is to be designed such that it relieves the order picker of physical exertion. In the case of the order-picking apparatuses which have been known up until now, the storage containers are presented to the order picker on a conveying arrangement, for example a conveying belt. On the one hand, such conveying arrangements involve high outlay and, on the other hand, adaptation of the order-picking workstation to the different requirements of the order pickers is not possible.

The object of the invention is to provide an order-picking apparatus of the abovementioned generic type which, along with the straightforward construction, allows more ergonomic order picking.

The object is achieved, in the case of an order-picking apparatus of the generic type, in that the storage container is presented on an adjustable table, and in that the transporting arrangement has a vehicle which transports the storage containers from the store to the table and back again into the store. In the case of the order-picking apparatus according to the invention, rather than taking place by way of an endless conveying installation, the transportation of the storage containers from the store to the order-picking workstation takes place by way of a vehicle.

The storage containers are brought to a table which is adjustable. The table can be adapted to the requirements of the order picker. The order-picking workstation is particularly ergonomic when, according to a development the invention, the table can be adjusted in inclination and/or height.

Particularly high performance is possible when, according to a development of the invention, the table is moved cyclically, by means of a drive, from a loading position into a removal position and from the latter into an unloading position, the table, in the loading position, being loaded with the container by the vehicle.

Such a cyclic progression can take place such that the table is oriented essentially horizontally in the loading position and is inclined in the removal position. The order-picking workstation may be designed with a plurality of transfer locations. It is then possible for the vehicle to discharge, for example, four storage containers and then to pick up four processed storage containers. This is possible, in particular, when, according to a development of the invention, at least two tables arranged one above the other are provided, it being possible for these to accommodate in each case at least two storage containers. It is also essential, in the case of such an arrangement, for the storage containers to be in easy reach for the order picker. It is thus not necessary for the order picker to cover large distances, which relieves him/her to a significant extent of physical exertion.

According to a development of the invention, the vehicle is provided with a gripping arrangement by means of which the storage containers can be stored and retrieved at the order-picking workstation and the container compartment. Such gripping arrangements allow the storage containers to be moved very quickly and reliably. A changeover at the order-picking workstation is then possible particularly quickly and reliably. As guide example of the order-picking apparatus according to the invention is explained in more detail hereinbelow with reference to the drawing, in which:

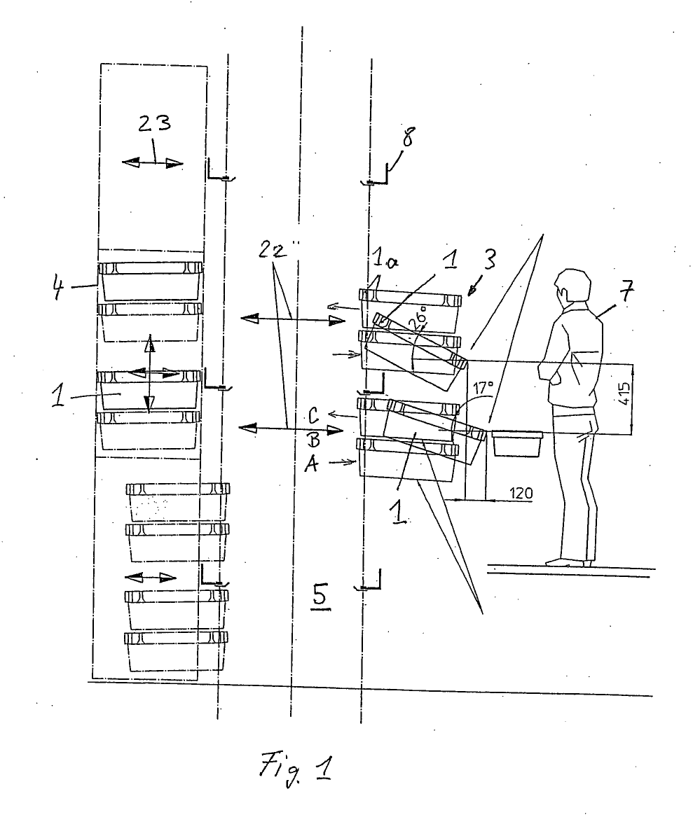

FIG. 1 shows, schematically, an order-picking workstation and a partial view of a store,

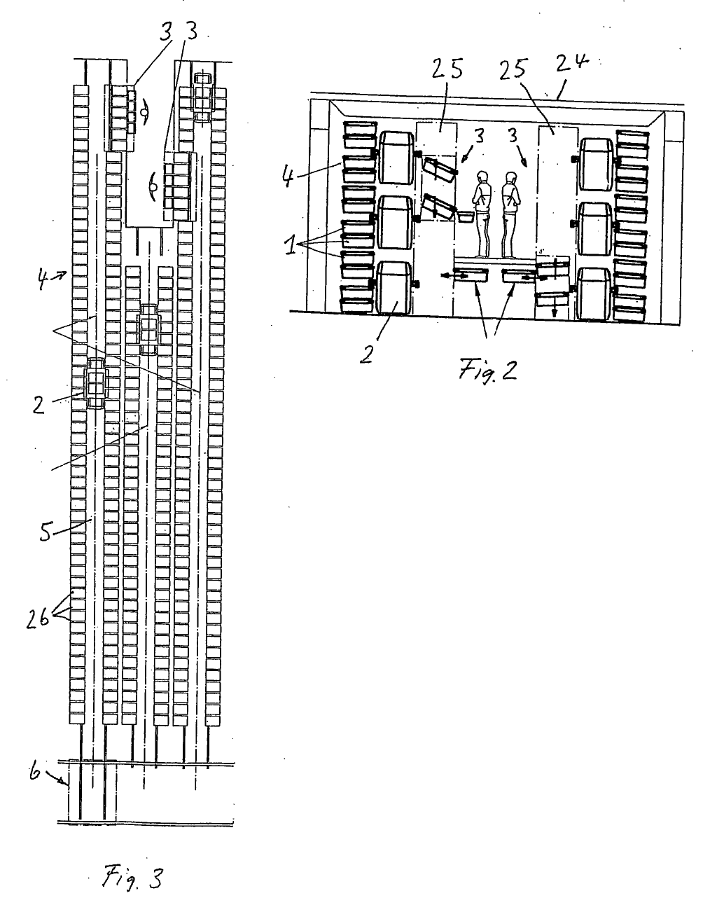

FIG. 2 shows, schematically, two order-picking workstations and a partial view of a store,

FIG. 3 shows, schematically, a view of an order-picking apparatus according to the invention,

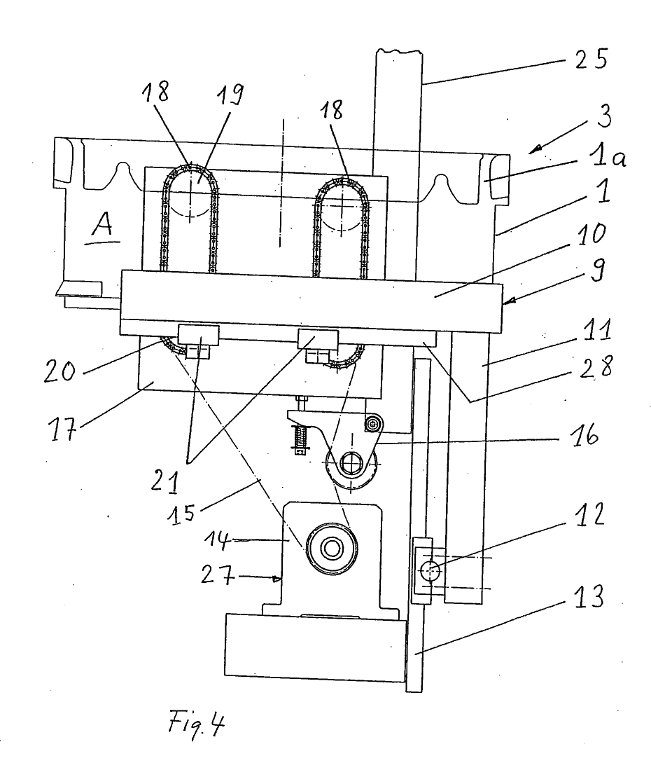

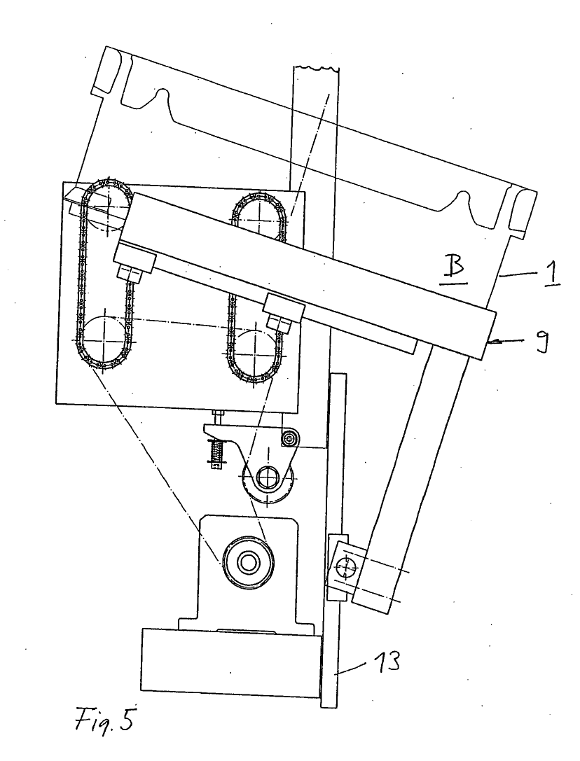

FIG. 4 shows, schematically, a view of a table and of the drive arrangement for this table, the table being located in the loading position,

FIG. 5 shows, schematically, a view according to FIG. 4, but with the table in the removable position,

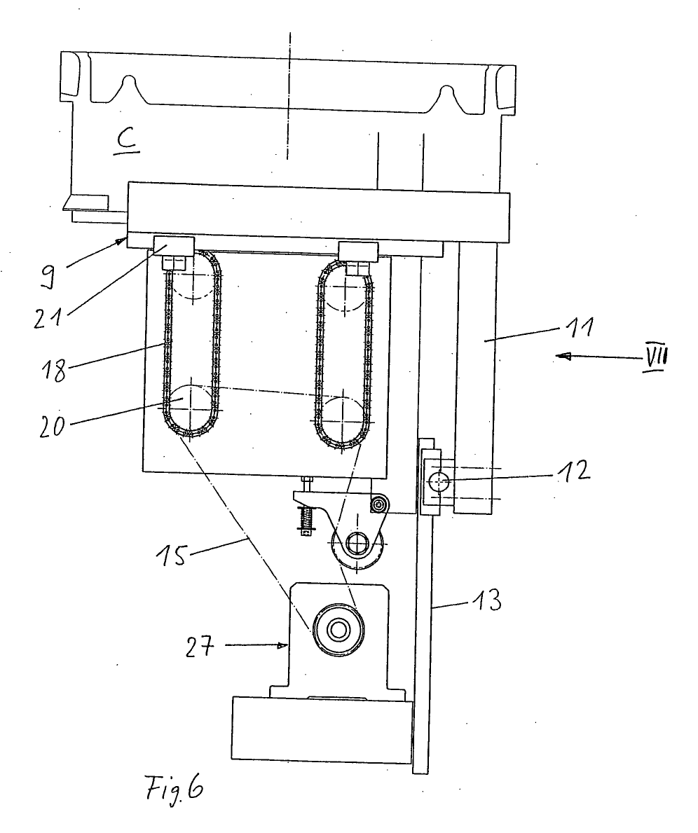

FIG. 6 shows, schematically, a view according to FIG. 4, but with the table in the unloading position,

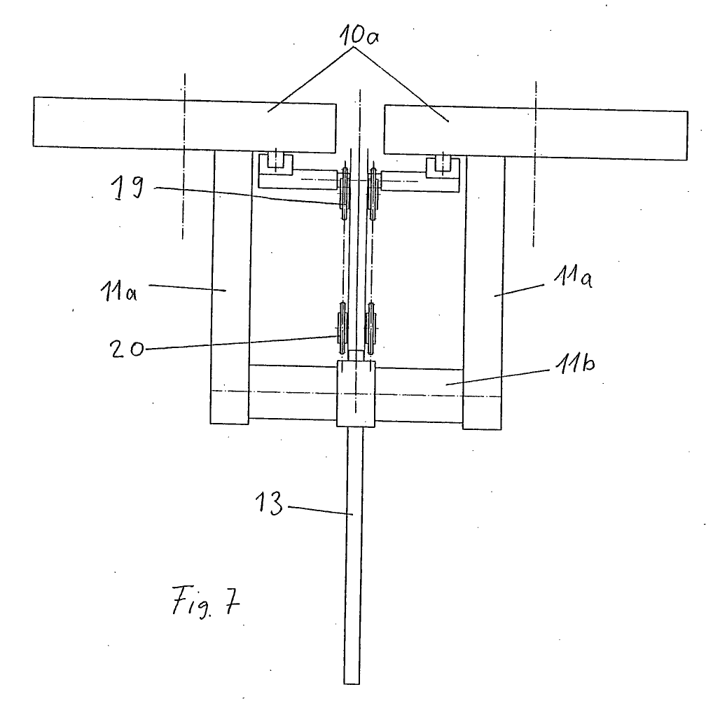

FIG. 7 shows, schematically, a view of the table in the direction of the arrow VII from FIG. 6, certain parts having been left out,

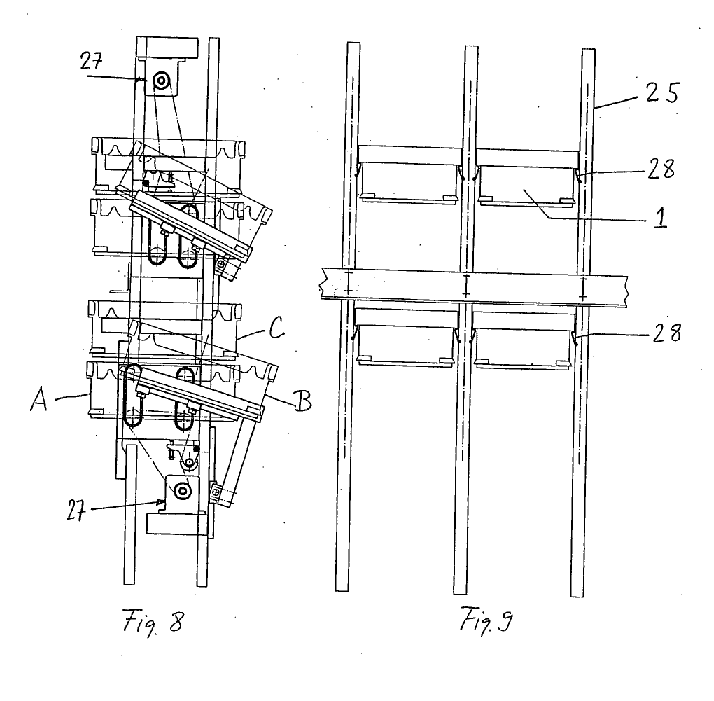

FIG. 8 shows, schematically, a view of an order-picking workstation with two tables arranged one above the other, and

FIG. 9 shows, schematically, a view of the rack with containers in the return storage position.

FIG. 1 shows an order picker 7 operating an order-picking workstation 3, in which he/she removes a certain number of articles in each case from storage containers 1 presented. Downstream of the order-picking workstation 3 is a storage aisle 5, in which vehicles 2 are guided horizontally on rails 8 according to FIG. 3. These vehicles 2 serve a store 4 that usually has a high number of container compartments 26, as can be seen in the figure. The vehicles 2 transport containers from the store 4 to the order-picking workstation 3 and back again into the store 4. By means of a lift 6, which is merely indicated in FIG. 3, the vehicles 2 can be moved from one story to the other. The vehicles 2 are controlled by a control arrangement (not shown here), and are thus moved automatically into the container compartment 26 and to the order-picking workstation 3. The storage containers 3 may be plastic containers which are known per se, are open at the top and have grooves 1a, which allow the containers 1 to be transported horizontally by means of, for example, a gripping arrangement. However, it is also possible, in principle, for the containers to be moved by other means.

FIG. 2 shows two order-picking workstations arranged opposite one another in a building 24. The store 4 indicated here has three stories, in which vehicles 2 can be displaced horizontally. Each vehicle 2 is provided with a gripping arrangement (not shown here) by means of which the storage containers 1 can be loaded and unloaded horizontally. In this respect, you are referred to WO 01 10751 A 1, which discloses a suitable vehicle and a suitable gripping arrangement. It is usually possible for the vehicle 2 to transport and pick up or discharge a plurality of containers 1 at the same time. For example, each vehicle 2 can discharge and pick up four storage containers 1. An order-picking workstation 3 has preferably two tables 9, which are arranged one above the other in a rack 25. However, it is also possible, in principle, to have a smaller or greater number of such tables 9 at an order-picking workstation.

Each table 9 has a pallet 10, which has two accommodating locations 10A for in each case one storage container 1. This pallet 10 is fastened on a carrier 11 which, according to FIG. 4, is mounted in a displaceable manner on a vertical guide rail 13, by means of a bearing 12, at the bottom end. The carrier 11, according to FIG. 5, comprises two parallel profile rods 11A and a crossmember 11B. In addition, the table 9 has a guide rail 28 which is fastened on the underside of the pallet 10 and on which two fastening elements 21 are guided in a displaceable manner. The fastening elements 21 are each fastened in a pivotable and releasable manner on an endless drive element 18. These two endless drive elements 18 are, for example, link chains and are each positioned around a wheel 19 and a wheel 20. These wheels 19 and 20 are mounted on a bearing plate 17. Driving takes place by a drive arrangement 27 which has an endless drive element 15 which is driven by a motor 14 and is tensioned by a tensioning arrangement 16. Two identical drive elements 18 are likewise mounted on the other side of the bearing plate 17, and a rail 28 is mounted thereon in each case, this resulting in the symmetrical arrangement which is shown in FIG. 7. The bearing plate 17 and the guide rail 13 are preferably fastened on the rack 25.

It is preferably, according to FIG. 8, for two tables 9 to be arranged one above the other. Each table 9 is driven by a drive arrangement 27. The two drive elements 18 of the drive 27 run in the same direction and synchronously in relation to one another. The inclination of the table 9 is brought about by the corresponding fastening of the two fastening elements 21 on the drive element 18. The fastening elements 21 are fastened in a releasable manner on the fastening elements 18 and can be offset in order to adjust the inclination of the tables 9. The fastening elements 21 may thus be fastened on any desired link of the drive element 18. With the motor 14 running, the following movement sequence of the table 9 is achieved:

On its cyclic path, each table 9 passes through the position shown in FIG. 5, in which the two storage containers 1 are inclined. This position forms the removal position B, in which the order picker 7 removes the envisaged articles from the storage containers 1. In the abovedescribed configuration with two tables 9 which each accommodate two storage containers 1, the order picker 7 is thus presented with four containers 1 in each case in ergonomically favorable positions. The inclinations of the two tables 9 arranged one above the other may be the same or different, as is shown in FIG. 8. The inclination of the bottom table 9 is, for example, 17°, while the inclination of the top table is somewhat greater and, for example, is 26°. It is possible to set the inclinations, as has been explained above, by adjustment of the fastening elements 21. In the inclined position, the drive remains at a standstill for a predetermined period of time. Order picking takes place within this period of time. The standstill period can be set via a timer (not shown here). If standstill takes place at an earlier point in time, then the table 9, in the removal position, is arranged at a lower level. If standstill takes place at a later point in time, then it does so, correspondingly, in a higher position. The timer can thus be used to adapt the height of the table 9 optimally to the requirements of the order picker. The order picker 7 can thus use the timer to set the height of the table 9 which is favorable for him/her.

Following order picking, the tables 9 are moved upward into the horizontal position C, which is shown in FIG. 6. The drive elements 18 here, in the view according to FIG. 5, run in the counterclockwise direction. Once the top horizontal position has been reached, then the containers 1 are brought into a return storage position in each case. For this purpose, according to FIG. 9, pivotable bars 28 or other suitable retaining means are arranged on the rack 25, the containers 1 being pushed onto said retaining means and the latter retaining the containers 1 in a withdrawable manner on the rack 25. The containers 1, then, thus hang in the rack 25 or on the bars 28 and can be removed by the vehicle 2. The tables 9 then move downward again, while the containers 1 from which orders have been picked remain in the above-mentioned return storage position on the framework 25, on the framework-mounted bars 28. During this movement of the tables 9, the containers 1 are withdrawn horizontally from the rack 25, in the direction of the arrows 29, by a vehicle 2 and are loaded onto the vehicle 2. The tables 9 have reached the bottom, loading position A, which is shown in FIG. 4. In this position, the two tables 9 are loaded with a total of four storage containers 1. The two loaded tables 9 are then moved into the removal position B, which is shown in FIG. 5, again. The vehicle 2, during a cycle, thus discharges onto the tables 9 four containers 1 from which orders are picked, and then picks up two containers 1 from which orders have been picked, and returns these into the store 4. The unloaded vehicle 2 is then loaded again and moved to an order-picking workstation. Thereafter, the abovementioned cycle is repeated in the same way. As FIG. 2 shows, the tables 9 are loaded, and the vehicle 2 is loaded with the containers 1 from which orders have been picked, on the rear side of the framework 25. The workstation of the order picker 7 is thus not restricted by these loading operations.

1. An order-picking apparatus with a transporting arrangement which transports the storage containers (1) from a store (4) to an order-picking workstation (3) and back again into the store (4), characterized in that the storage containers (1) from which orders are to be picked are presented on an adjustable table (9), and in that the transporting arrangement has at least one vehicle (2) which transports the storage containers (1) from the store (4) to the table (9) and back again into the store (4).

2. The apparatus as claimed in claim 1, characterized in that the table (9) is moved cyclically, by means of a drive arrangement (27), from a loading position (A) into a removal position (B) and from the latter into an unloading position (C), the table (9), in the loading position (A), being loaded with containers (1) by the vehicle (2).

3. The apparatus as claimed in claim 1, characterized in that the height and/or the inclination of the table (9) can be adjusted.

4. The apparatus as claimed in claim 1, characterized in that the table (9) is arranged in a rack (25).

5. The apparatus as claimed in claim 1, characterized in that the table (9) can be displaced vertically, and in that the unloading position (C) is arranged above the removal position (B), and the latter is arranged above the loading position (A).

6. The apparatus as claimed in claim 1, characterized in that the containers (1), in the unloading position (C), are retained on the rack (25) at a return storage location in each case.

7. The apparatus as claimed in claim 6, characterized in that the storage containers (1), in the return storage position, are retained in a withdrawable manner on the rack (25) by retaining means (28).

8. The apparatus as claimed in claim 1, characterized in that the table (2) is fastened spaced-apart endless drive elements (18).

9. The apparatus as claimed in claim 8, characterized in that the table (9) is fastened in an adjustable manner on the two drive elements (18).

10. The apparatus as claimed in claim 8, characterized in that the two drive elements (18) are link chains or toothed belts.

11. The apparatus as claimed in claim 1, characterized in that the table (9) is loaded and unloaded from the rear, as seen by the order picker (7).

12. The apparatus as claimed in claim 1, characterized in that the vehicle (2) is designed such that it can serve the order-picking workstation (3) simultaneously in each case with a plurality of storage containers (1).

13. The apparatus as claimed in claim 1, characterized in that the table (9) accommodates at least two storage containers (1).

14. The apparatus as claimed in claim 1, characterized in that the order-picking workstation (3) has at least two tables (9) arranged one above the other.

15. The apparatus as claimed in claim 14, characterized in that the two tables (9) are controlled such that they are arranged essentially simultaneously in a removable position (B).
